(19) United States
(12) Patent Application Publication
(10) Pub. No.: US 2003/0234470 A1
(43) Pub. Date: Dec. 25, 2003

(54) Embossing apparatus, method of use thereof and resulting article

(76) Inventors: Stephen F. Haan, Pittsfield, MA (US); Matthew Frank Niemeyer, North Chatham, NY (US); David P. Reis, Lenox, MA (US); Richard P. Theriault, Pittsfield, MA (US)

Correspondence Address: CANTOR COLBURN, LLP, 55 GRIFFIN ROAD SOUTH, BLOOMFIELD, CT, 06002

(21) Appl. No.: 10/064,194

(22) Filed: Jun. 20, 2002

(51) Int. Cl. H05B 6/02; B29C 59/02

(52) U.S. Cl. 264/293; 264/486; 264/487; 425/406

(57) ABSTRACT

Disclosed herein is an embossing apparatus, methods of use thereof and articles produced therefrom. In one embodiment, the method of forming an embossed substrate comprises: disposing a substrate a platen and a stamper comprising a negative of a desired surface feature, wherein the stamper is affixed to a magnetically permeable block comprising an induction coil, and wherein the stamper comprises a relative magnetic permeability gradient, pressing the stamper and the substrate together, passing an alternating electrical current through the induction coil, and changing the alternating electrical current in the induction coil. This apparatus is particularly useful for the manufacture of data storage media.

### BACKGROUND OF INVENTION

This disclosure is related to an embossing apparatus, methods of its use and articles resulting from the use of such an apparatus.

Embossing is a technique for imparting surface features into a substrate using a patterned stamper. The technique comprises disposing the stamper and substrate between two platens of a press, where the area of the stamper comprising the desired surface features faces and is in alignment with the area of the substrate to receive the features. The press platens are then closed and sufficient heat and pressure are applied to transfer the features of the stamper to the substrate. The embossed surface features can have a depth of up to about 200 nanometers (nm). Deeper features or features that vary outside the ranges can be produced, but, in general, for flying head applications, these can result in undesirable head-disk interactions. In the lateral dimension, the surface features, particularly of a magnetic data storage media, preferably have a “short” dimension of up to or exceeding about 250 nm, with less than about 200 nm more preferred, less than about 150 nm even more preferred, and less than about 100 nm especially preferred.

Since the embossing of substrates comprising a polymeric material is often carried out at elevated temperatures, the heating of the stamper as well as the platens of the press requires long cycle times. Often, it may be desirable for the substrate to be preheated in an oven before transferring to the heated press and the time-temperature dependency of transferring a pre-heated substrate adds variation to the process that makes it difficult to control tight dimensional tolerances required for embossing. Additionally, it may be desirable to cool the press before removal to minimize deformation and damage to the substrate. All of these factors cause an increase in the cycle time required for production and therefore create a need for improved tools as well as methods for embossing substrates comprising polymeric materials.

### SUMMARY OF INVENTION

Disclosed herein are methods of forming an embossed substrate, an embossing apparatus, method of use thereof and articles produced therefrom. In one embodiment, a method of forming an embossed substrate, comprises: disposing a substrate between a platen and a magnetically impermeable stamper affixed to a magnetically permeable block comprising an induction coil, pressing the stamper and the substrate together, passing an alternating electrical current through the induction coil, and changing the alternating electrical current in the induction coil.

Another embodiment of method of forming an embossed substrate, comprises: disposing a substrate a platen a stamper, pressing the stamper and the substrate together, passing an alternating electrical current through the induction coil, and changing the alternating electrical current in the induction coil. In this embodiment, the stamper is affixed to a magnetically permeable block comprising an induction coil. The stamper comprises a negative of a desired surface feature and a relative magnetic permeability gradient.

In one embodiment, the apparatus for embossing comprises: a first magnetically permeable block comprising an induction coil disposed in a recess and a first stamper disposed in operable communication with to the first magnetically permeable block.

The above described and other features are exemplified by the following figures and detailed description.

### BRIEF DESCRIPTION OF DRAWINGS

Referring now to the drawing, wherein like elements are numbered alike:

FIG. 1 is a cross-sectional view of the stamper affixed to a magnetically permeable block containing the induction coil and thermal channel.

### DETAILED DESCRIPTION

Small three-dimensional features can be embossed on a substrate comprising a polymeric material by utilizing a stamper, the temperature of which is controlled by an electrical current flowing through an induction coil contained in a magnetically permeable block to which the stamper is attached. The control of the stamper or detachable mold insert may also be driven by additional non-contact heating methods such as: convective heating, IR heating, thermal conduction, and the like. The stamper is brought into contact with the substrate and, under pressure, the temperature of the stamper is elevated above the softening temperature of the surface upon which the surface features are to be transferred. After the features on the stamper are transferred onto the surface, the stamper is subsequently cooled below the softening temperature of the substrate or to a temperature that facilitates optimum release while preserving the replication of the features. The substrate is subsequently removed without distortion or deformation and the process is repeated. Thus by heating and cooling the stamper, while applying pressure embossing of substrates comprising polymeric media can be efficiently carried out. The method described herein is useful, for example, for producing data storage media.

The stamper, employed to impart surface features to substrate, can comprise a magnetically impermeable material (i.e., a material having a relative magnetic permeability (where relative refers to in relation to air) of greater than or equal to about 400. It is understood that the relative magnetic permeability chosen for the stamper can be focused on maximizing heating capabilities, maximizing temperature uniformity, or a combination thereof. It is believed that greater temperature uniformity can be attained at lower relative magnetic permeability, while improved heating capabilities can be attained at higher relative magnetic permeabilies. Stamper magnetic permeabilities of as low as about 200 can be employed, but for heating efficiencies, relative magnetic permeabilities of greater than or equal to about 500 are preferred. The substrate can comprise metal, glass, ceramic, plastic, as well as alloys, cermets, reaction products, composites, and mixtures comprising at least one of the foregoing, in combination with magnetically impermeable fillers where needed to attain the desired relative magnetic permeability.

In an alternative embodiment, as opposed to having the magnetically impermeable material be disposed throughout the stamper, the stamper can comprise a magnetically impermeable portion or a permeability gradient. For example, a portion of the stamper can have a magnetic permeability of less than or equal to about 100 and another portion, e.g., a receiver, can have a magnetic permeability of greater than or equal to about 400. In this case, the receiver can either be disposed between the block and the stamper or can be the surface of the stamper comprising the negative. With respect to the permeability gradient, the stamper can have a relative magnetic permeability gradient through the stamper designed to enhance temperature uniformity and to increase sensitivity to induction heating. This gradient can be formed by disposing appropriate concentrations of magnetically impermeable material at different depths through the stamper.

The stamper is affixed to a magnetically permeable block that contains the inductive coils for heating the stamper. In order to attain the desired heating, the stamper should have a greater relative magnetic permeability than the block. Preferably, difference in relative magnetic permeability is greater than or equal to about 200, with greater than or equal to 1,000 more preferred. Generally, the stamper can comprise a material having a relative magnetic permeability of greater than or equal to about 400. Preferably, the stamper relative magnetic permeability is greater than or equal to about 1,000, more preferably greater than or equal to about 1,500. The stamper, which can be rigid or flexible, comprises a material that retains structural integrity under the embossing (e.g., hot press) conditions. Additionally, since the stamper is repeatedly heated and cooled, it is desirable that the stamper be capable of absorbing the thermal cycling (e.g., the heating and cooling) for greater than or equal to about 10,000 cycles, preferably greater than or equal to about 100,000 cycles, more preferably greater than or equal to about 1,000,000 cycles or so.

Preferred stamper materials include silicon, nickel, iron, cobalt, manganese, gadolinium, dysprosium, oxides such as iron oxide, ferrites (such as LiZn (lithium zinc) ferrites, MgMnZn (magnesium manganese zinc) ferrites, and the like), cermets, alloys, laminates, and combinations comprising at least one of the foregoing materials. Nickel, as well as alloys and combinations comprising nickel are more preferred.

The stamper is typically formed from a master. The master can be produced with the desired surface features using various techniques, including laser writing, e-beam, photolithography, mechanical abrasive systems, related methods, and combinations comprising at least one of the foregoing techniques. Following a finishing step that is dictated by the type of method used (e.g., photoresist development for lithography based system), the stamper can be produced from the master by a number of methods (e.g., a nickel plating operation) to produce a negative image of the features of interest. Additionally, different types of texturing can be produced on the stamper at the same time, by producing one or more zones of texture on the master (e.g., data zone, start/stop zone, and the like). Methods for multizone texturing is described, for example, in U.S. Pat. No. 5,798,164.

The stamper is disposed in a device comprising a block of low relative magnetic permeability (e.g., less than or equal to about 10) containing the induction coil and the thermal channel is generally made from a magnetodielectric material (MDM). With a low relative magnetic permeability and high electrical resistivity, the MDM concentrates the induced power in desired areas of the stamper to facilitate rapid heating. Preferably, the block has a relative magnetic permeability of less than or equal to about 5, with less than or equal to about 2 more preferred, and a relative magnetic permeability of about 1 especially preferred.

The induction coil, which is in magnetic communication with the block and the stamper is connected to a power source that supplies the electrical current for heating. The location of the induction coil within the block preferably such that the stamper is heated homogenously upon application of the current. In order to rapidly cycle the temperature of the stamper above and below the softening temperature of the polymeric material to be embossed, the induction coil is preferably embedded in a block with a low relative magnetic permeability (e.g., less than or equal to about 10).

In an alternative embodiment, a recessed chamber comprising a pressurized medium behind the stamper can be employed as the primary mode of communicating the stamper pattern to the substrate surface, i.e., the stamper is in operable communication with the block via the pressurized medium and with the induction coil via the magnetic field. This gives the opportunity to pressurize in a non-contact mode. In this embodiment, the induction coils could be supported in the pressurized medium, in a recessed pocket in the block. Since the induction coil employs a magnetic field to heat, heating can be accomplished without physical contact with the stamper. In this embodiment, it may be preferable to employ a stamper with a lower heat capacity than the substrate. If the heat capacity of the substrate is greater than the heat capacity of the stamper, once the magnetic field is turned off, the substrate will pull the heat from the stamper, thereby reducing the temperature of the stamper and the substrate surface (e.g., coating) in contact with the stamper.

In order to facilitate thermal transfer, the block may further comprise thermal channel(s) in thermal communication with the stamper. In fluid communication with the thermal channel(s) is a medium that provides the desired convective capacity for cooling, and optionally heating. The thermal channel(s) are preferably designed within the block to maximize the cooling of the stamper after the features are transferred from stamper to polymeric surface. Optionally, the induction coil can form the thermal channels. For example, the induction coil can be a conduit (e.g., copper tubing or otherwise hollow coil), through which the thermally convective medium can pass. Alternatively, a channel formed in the block can be plated (or otherwise coated) with an electrical conductor. The plating will function as the induction coil, and a medium passed through the plated channel(s) will function as the thermal fluid.

The thermal material employed in the thermal channel(s) can comprise a gas, liquid, solid or a combination thereof. It is generally desirable to use a liquefied gas such as liquid nitrogen, liquid carbon dioxide, liquid helium, and the like, as well as combinations comprising at least one of the foregoing thermal fluids, with inert liquefied gases, such as liquid nitrogen, preferred. Other suitable fluids for cooling the stamper are hydrocarbon oils, hydro chlorofluorocarbons, hydro fluorocarbons, halo fluorocarbons, water-soluble emulsions and non-hydrocarbon oils (e.g. silicones). The coolant fluid may contain corrosion inhibitors as well as biostable products that inhibit bacterial and fungal growth. Slurries may also be used as coolants, such as slurries comprising dry ice and solvents such as acetone, methyl ethyl ketone, methanol, ethanol, isopropanol, and the like. Various combinations comprising at least one of the foregoing thermal fluids can also be employed.

During use, the magnetically permeable block with the affixed stamper is placed into a clamping ring or similar device that affixes the block to the press. The clamping ring generally comprises a material capable of withstanding the temperatures and pressures associated with the embossing process, and which will not absorb the magnetic fields generated by the induction coil(s). The material for the clamping ring may be a metal, glass, ceramic, and alloys, cermets, composites, reaction products, and mixtures comprising at least one of the foregoing materials, with ferrous materials such as stainless steels and the like preferred.

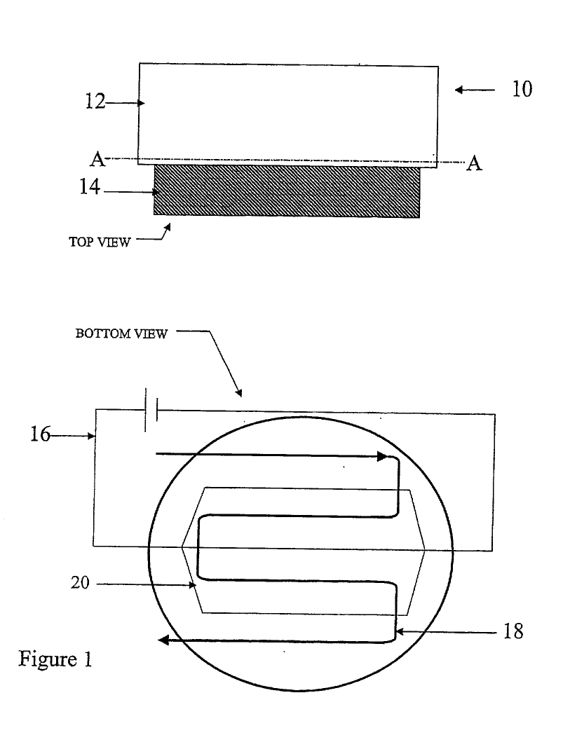

Referring to A preferred configuration of the magnetically permeable block with the stamper 10 is shown in the top view of FIG. 1. The top view shows the stamper 14 attached to the magnetically permeable block 12. A cross sectional view of the section ‘AA’ of the magnetically permeable block 12 is depicted in the bottom view of the figure. This cross sectional view illustrates the portion of the magnetically permeable block 12 closest to the stamper 14. This portion of the magnetically permeable block 12 further comprises induction coils 20 with the associated electrical circuitry 16 which may be connected to an external source of electricity. The flow of electrical current through the induction coils 20 may be used to heat and cool the stamper 14. This portion of the magnetically permeable block 12 also contains the thermal channel 18 through which the coolant circulates to cool the stamper. In additional to the auxiliary cooling coils in the mirror block it is also conceivable to have cooling fluid running through the hollow induction heating coils or tubing.

The press is preferably capable of applying uniform pressure and maintaining uniform contact between the stamper and the substrate. For data storage and media applications, typically, a press capable of attaining pressures of greater than or equal to about 100 pounds per square inch (psi) and temperatures of greater than or equal to about 150° C. can be employed, with a press capable of attaining pressures of greater than or equal to about 1,000 psi and temperatures of greater than or equal to about 250° C. preferred, a press capable of attaining pressures of greater than or equal to about 2,000 psi and temperatures of greater than or equal to about 300° C. even more preferred. Since the temperature and pressure are dependent upon the specific material, it is understood that pressures of up to and exceeding about 3 tons per square inch (tsi) and temperatures up to and exceeding about 400° C. can be employed.

Although this embossing technique can be employed in any hot press application where a pattern is transferred to a substrate comprising a polymeric material, it is particularly useful in forming data storage media. The data storage media can comprise a substrate comprising metal, glass, ceramic, plastic, or alloys, cermets, composites, reaction products, and mixtures comprising at least one of the foregoing substrates. The non-plastic substrates further comprise a plastic layer on at least a portion of one side of the substrate.

In addition to the substrate and, if non-plastic, the plastic coating, the storage media can also comprise layers applied to the substrate may include one or more data storage layer(s) (e.g., magnetic, magneto-optic, etc.), protective layer(s), dielectric layer(s), insulating layer(s), combinations comprising at least one of the foregoing layers, and others. The data storage layer(s) may comprise a material capable of storing retrievable data, such as an optical layer, magnetic layer, or a magneto-optic layer, having a thickness of less than or equal to about 600 Å, with a thickness of less than or equal to about 300 Å preferred. Possible data storage layers include, but are not limited to, oxides (such as silicone oxide), rare earth element—transition metal alloy, nickel, cobalt, chromium, tantalum, platinum, terbium, gadolinium, iron, boron, and the like; organic dye (e.g., cyanine or phthalocyanine type dyes), and inorganic phase change compounds (e.g., TeSeSn or InAgSb), and the like; as well as alloys and combinations comprising at least one of the foregoing. Preferably, the data layer has a coercivity of greater than or equal to about 1,500 oersted, with a coercivity of greater than or equal to about 3,000 oersted especially preferred.

The protective layer(s), which protect against dust, oils, and other contaminants, can have a thickness of greater than or equal to about 100 microns (μ) to less than or equal to about 10 Angstrom (Å), with a thickness of less than or equal to about 300 Å preferred in some embodiments. In another embodiment, a thickness less than or equal to about 100 Å is especially preferred. The thickness of the protective layer(s) is usually determined, at least in part, by the type of read/write mechanism employed, e.g., magnetic, optic, or magneto-optic. Possible protective layers include anti-corrosive materials such as nitrides (e.g., silicon nitrides and aluminum nitrides, among others), carbides (e.g., silicon carbide and others), oxides (e.g., silicon dioxide and others), polymeric materials (e.g., polyacrylates or polycarbonates), carbon film (diamond, diamond-like carbon, etc.) among others, and combinations comprising at least one of the foregoing.

The dielectric layer(s), which are optionally employed as heat controllers, can typically have a thickness of greater than or equal to about 1,000 Å and as low as about 200 Å or so. Possible dielectric layers include nitrides (e.g., silicon nitride, aluminum nitride, and others); oxides (e.g., aluminum oxide); carbides (e.g., silicon carbide); and combinations comprising at least one of the foregoing, among other materials compatible within the environment and preferably not reactive with the surrounding layers.

The reflective layer(s) should have a sufficient thickness to reflect a sufficient amount of energy to enable data retrieval. Typically the reflective layer(s) can have a thickness of less than or equal to about 700 Å, with a thickness of about 300 Å to about 600 Å generally preferred. Possible reflective layers include any material capable of reflecting the particular energy field, including metals (e.g., aluminum, silver, gold, titanium, and alloys and mixtures comprising at least one of the foregoing, and others). In addition to the data storage layer(s), dielectric layer(s), protective layer(s) and reflective layer(s), other layers can be employed such as lubrication layer and others. Useful lubricants include fluoro compounds, especially fluoro oils and greases, and the like.

In theory, the plastic substrate and/or plastic coating on the substrate can comprise a plastic that exhibits appropriate properties, e.g., the plastic should be capable of withstanding the subsequent processing parameters (e.g., application of subsequent layers) such as sputtering (i.e., temperatures of room temperature up to and exceeding about 200° C. (typically up to or exceeding about 300° C.) for magnetic media, and temperatures of about room temperature (about 25° C.) up to about 150° C. for magneto-optic media). That is, it is desirable for the plastic to have sufficient thermal stability to prevent deformation during the deposition steps. For magnetic media, appropriate plastics include thermoplastics with softening temperatures preferably of greater than or equal to about 100° C., more preferably greater than or equal to about 150° C., and most preferably greater than or equal to about 200° C. (e.g., polyetherimides, polyetheretherketones, polysulfones, polyethersulfones, polyetherethersulfones, polyphenylene ethers, polyimides, high heat polycarbonates, and the like, as well as reaction products and combinations comprising at least one of the foregoing materials); with materials having softening temperatures of greater than or equal to about 250° C. even more preferred (e.g., polyetherimide in which sulfonedianiline or oxydianiline has been substituted for m-phenylenediamine, polyimides, and the like, as well as reaction products and combinations comprising at least one of the foregoing materials).

Additionally, it is possible for thermosets to be used in the application provided the thermoset possess sufficient flow (gelled) under the stamping conditions to permit formation of the desired surface features. As various applications may require polymers with different softening temperatures, it may be advantageous to be able to adjust the softening temperature of a plastic (homopolymer, copolymer, or blend) to achieve a film with the desired softening temperature. To this end, polymer blends, such as those described in U.S. Pat. No. 5,534,602 (to Lupinski and Cole, 1996), may be employed in the preparation of the coating solution. In this example, polymer blends provide, selectively, variable softening temperatures of about 190° C. to about 320° C.

Some possible examples of thermoplastics include, but are not limited to, amorphous materials, crystalline materials, semi-crystalline materials, and reaction products and combinations comprising at least one of the foregoing materials. For example the plastic can comprise: polyvinyl chloride, polyolefins (including, but not limited to, linear and cyclic polyolefins and including polyethylene, chlorinated polyethylene, polypropylene, and the like), polyesters (including, but not limited to, polyethylene terephthalate, polybutylene terephthalate, polycyclohexylmethylene terephthalate, and the like), polyamides, polysulfones (including, but not limited to, hydrogenated polysulfones, and the like), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate, methyl methacrylate-polyimide copolymers, and the like), polyacrylonitrile, polyacetals, polycarbonates, polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, polytetrafluoroethylene. The plastic may also or alternatively comprise thermosetting resins such as epoxy, phenolic, alkyds, polyester, polyimide, polyurethane, mineral filled silicone, bis-maleimides, cyanate esters, vinyl, and benzocyclobutene resins. Additionally, the plastic may comprise blends, copolymers, mixtures, reaction products and composites comprising at least one of the foregoing thermoplastics and/or thermosets.

Optionally, the plastics coating can comprise a material that is thermally sensitive to the magnetic field. This material will, upon exposure to the magnetic field, facilitate heating of the coating to the desired embossing temperature. The material, which is in a form that will not adversely effect the embossed features or degree of replication, can comprise materials listed as possible stamper materials.

Formation of the storage media can comprise applying the plastic to the substrate. The plastic layer can be deposited by a variety of techniques, including spin coating, vapor deposition (e.g. plasma enhanced chemical vapor deposition), electrodeposition coating, meniscus coating, spray coating, extrusion coating, film lamination, and the like, and combinations comprising at least one of the foregoing techniques. In order to improve adhesion of the coating to the substrate, optionally, an adhesion promoter, such as an organosilane or another conventional adhesion promoter, can be used. Possible organosilanes include VM-651 and VM-652 commercially available from DuPont. If an adhesion promoter is employed, it is typically dissolved in a solvent, such as methanol, water, and combinations comprising at least one of the foregoing, and is applied to the substrate prior to applying the plastic bead. Once the adhesion promoter is spin coated onto the substrate, the plastic coating is applied.

Once the plastic coating is applied the substrate can be embossed. Not to be limited by theory, due to the rheology of the plastic material, not only can pits, grooves, and edge features be embossed into the substrate, but the desired surface quality can also be embossed (e.g., desired smoothness, roughness, micro-waviness, microtexturing, and flatness). In one embodiment, embossed bit-patterns and/or servo-patterns have a depth of up to about 200 nm or greater, with depths greater than or equal to about 4 nm preferred, greater than or equal to about 10 more preferred, and greater than or equal to about 20 nm even more preferred. On the upper end, depths of less than or equal to about 150 nm are preferred, with depths of less than or equal to about 50 nm especially preferred. In the lateral dimension, the surface features, particularly of a magnetic data storage media, would preferably have a “short” dimension of up to or exceeding about 250 nm, with less than or equal to about 200 more preferred, less than or equal to about 150 nm even more preferred, and less than or equal to about 100 nm especially preferred.

In an alternative embodiment, e.g., in read/write disks, microtexturing can be embossed onto the plastic coating. Based on the desire for increased aerial storage density, read/write heads need to be flown closer to the surface of the disk (e.g., a flight height usually less than or equal to about 0.05 μm). However, if the surface of the disk is too smooth, poor tribology performance between the head and disk can be experienced, e.g., mainly due to an increased surface area of contact during operational head-disk interactions. Consequently, the requirements for smoother media should be balanced by demands for improved reliability and tribology. Additionally, the application of texture in the data zone is preferred for magnetic orientation (e.g., in magnetic or magneto-optic media). A circumferential texture can aid in the proper orientation of the magnetic grain grown on the surface of the substrate, yielding improved magnetic performance in the resulting media.

Consequently, microtexturing of a desired design and/or orientation can also be embossed into the plastic coating. The microtexturing can have a depth of less than or equal to about 10 , with a depth of less than or equal to about 6 nm preferred, and a depth of less than or equal to about 3 nm even more preferred; wherein the depth is the vertical distance from the plane of the substrate surface to the low point of the valley of the texture. The lower limit on this section is merely based upon the desired characteristics which the microtexturing is intended to address, for example, tribology, grain orientations, and the like. For example, in a magnetic media, the microtexturing preferably has a sufficient depth to enable desired grain growth orientation. Microtexturing for a head contact start/stop zone can have a height or depth of less than or equal to about 30 nm, with a height or depth of less than or equal to about 25 nm preferred, and a height or depth of less than or equal to about 20 nm even more preferred. (Height is measured from the plane of the substrate surface to the high point of the texture.) The lower limit on this height or depth is preferably based upon a sufficient height to minimize the surface area contact of the head to the disk surface during start/stop conditions; i.e., the area of the head resting on the disk when the head is not in flight is minimized.

During the embossing, the substrate is disposed between two platens of a mold with at least a portion of the plastic aligned with a stamper. Once the mold platens close, at least a portion and preferably the entire stamper surface contacts at least a portion of the substrate plastic surface. It is desirable to have substantially the entire substrate surface aligned with the stamper surface and in intimate physical contact with the stamper such that efficient and effective transfer of the stamper surface features is attained. For dual sided media, it is preferred that the center of the pattern on the stamper is aligned with the center of the media, on both sides of the media.

In one embodiment, the stamper surface contacts the substrate/coated substrate surface under minimal pressure until the flow of current to the induction coil is started. The pressure maintains uniform contact between the stamper and the substrate, and preferably also between the stamper and the surface of the block. The amount of current flowing through the coil is then controlled, optionally in conjunction with the flow rate of coolant in the thermal channel(s), to control the temperature of the stamper and therefore, the substrate surface. Once the surface of the substrate is above the softening temperature, and sufficient pressure has been applied to transfer the stamper pattern onto the substrate surface, the current is varied to enable a decrease in temperature of the substrate surface to be sufficiently below the softening temperature to enable release of the substrate from the stamper without damaging the pattern features formed thereon.

The temperature of the stamper is varied during the process of embossing. In one embodiment, the temperature of less than or equal to about 60° C., preferably less than or equal to about 50° C., more preferably greater than or equal to about 40° C., and most preferably greater than or equal to about 20° C., above the softening temperature of the material is employed before the application of increased pressure to emboss the material. After the embossing has taken place the temperature of the stamper is reduced to be below the softening temperature of the embossed surface by an amount less than or equal to about 60° C., preferably less than or equal to about 50° C., more preferably less than or equal to about 40° C., most preferably less than or equal to 20° C., from the softening temperature, in order to facilitate removal of the substrate from the stamper and press without substantial distortion or damage to the embossed surface.

In addition to heating the stamper and the press, the substrate can optionally be heated (e.g., convection, IR, and the like), e.g., before introduction to the press, to a temperature greater than or equal to the softening temperature of the plastic to reduce the press time. The substrate can be heated to a temperature sufficient to facilitate replication of the surface features onto the substrate. Typically, the substrate is heated up to about 5° C. above the softening temperature or less for crystalline material, with greater than about 5° C. above the glass transition temperature preferred for amorphous materials.

For storage media, once the substrate has been coated with plastic, and embossed with the appropriate surface features, if desired, various layers can then be applied to the substrate through one or more techniques, e.g., sputtering, chemical vapor deposition, plasma-enhanced chemical vapor deposition, reactive sputtering, evaporation, and the like. For example, in some cases, high aerial density storage media might have pits and grooves on the polymer substrate that can be solely geographic locators; i.e., they are not required to store data therein. The data is stored in data storage layer(s). Furthermore, the data stored in the data storage layer (s) may be changed or rewritten.

Typically it is desirable to use the stamper to emboss surface areas exceeding about 25 cm², with surface areas exceeding about 50 cm² readily embossable, surface areas of about 75 cm² or greater practical, and surface areas of about 100 cm² and greater embossable. With the present process, a surface feature replication of virtually always greater than or equal to about 85%, with greater than or equal to about 95% preferred, with greater than or equal to about 97% more preferred, and greater than or equal to about 99% even more preferred, and about 100% possible for up to and exceeding about 1,000,000 embossing runs. This method can also facilitate embossing into non-flat parts. The soft press in conjunction with the induction heating would be preferable for non-flat substrate. It can also allow for more accurate replication of extremely small features (lateral dimensions of less than or equal to about 100 nm, and even as small as about 10 nm or less) with equally shallow depths. It also enables embossing of features having a depth on the substrate (i.e., a height on the negative) of greater than or equal to about 50% of the thickness of the plastic component, with a surface feature depth of up to about 60% or greater, up to about 75% or greater, and even up to about 85% of the plastic component thickness or greater possible.

In the areas of data storage, the embossing technique can be used in several areas. For magnetic data storage, embossing of servo marks allows for the potential of improved tracking and cost reduction by elimination of a separate servo-writing step. Embossing could also be used to produce bit-patterned media for purposes of increasing areal density and improving thermal stability through the production of decoupled magnetic domains. Embossing for optical data storage media is an alternative to injection molding process. Finally, for magneto-optical, embossed features could be used for tracking or servo information. It is also understood that this embossing apparatus and technique can be employed for multi-sided substrates (e.g., two sided data storage media). In this case, induction coils could be employed on one or both sides of the substrate in conduction with one or both of the stampers.

The present process employing the induction coil enables reduced cycle times potentially from a heat up cool down cycle time of several minutes (e.g., about 5 to about 30 minutes) to a manageable sub-one minute cycle. In other words, with a cycle of less than or equal to about 1 minute, the cycle time has been reduced by at least about 80%. Early experimentation using the induction coil system resulted in heat up times of about 1 to about 3 seconds and increased While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of forming an embossed substrate, comprising:
disposing a substrate a platen a magnetically impermeable stamper comprising a negative of a desired surface feature, wherein the stamper is affixed to a magnetically permeable block comprising an induction coil;
pressing the stamper and the substrate together;
passing an alternating electrical current through the induction coil to raise the temperature of the stamper above a softening temperature of a substrate surface; and
changing the alternating electrical current;
whereby the embossed substrate is formed.

2. The method of claim 1, wherein the relative magnetic permeability of the stamper is in an amount of about 400 to about 800.

3. The method of claim 1, wherein the stamper comprises a material selected from the group consisting of nickel, iron, cobalt, manganese, gadolinium, dysprosium, iron oxide, lithium zinc ferrites, magnesium manganese zinc ferrites, cermets and alloys comprising at least one of the foregoing materials.

4. The method of claim 1, wherein the stamper comprises a magnetically permeable material and a resin selected from the group consisting of polyphenylene sulfide, polythalamide, polyimides, polyetherimides, epoxy molding compounds, crosslinked silicones, phenols, polyphenylene ethers, reaction products and compositions comprising at least one of the foregoing resins.

5. The method of claim 1, wherein magnetically permeable block has a relative magnetic permeability of about 1 to about 2.

6. The method of claim 1, wherein the magnetically permeable block further comprises a recess adjacent to the magnetically impermeable stamper, and a gas source in fluid communication with the recess.

7. The method of claim 6, wherein the induction coil is disposed in the recess.

8. The method of claim 1, wherein the stamper further comprises a portion having a magnetic permeability of less than or equal to about 100 and a receiver having a magnetic permeability of greater than or equal to about 400.

9. The method of claim 8, wherein the receiver comprises the negative.

10. The method of claim 1, wherein the induction coil comprises a hollow conduit forming a thermal channel, and further comprising flowing a thermally convective medium through the thermal channel.

11. The method of claim 10, further comprising flowing thermally convective medium through the thermal channel to cool to a temperature below the softening temperature.

12. The method of claim 1, further comprising disposing a layer on the embossed substrate, wherein the layer is selected from the group consisting of a data storage layer, a protective layer, a dielectric layer, a reflective layer, and combinations comprising at least one of the foregoing layers.

13. A method of forming an embossed substrate, comprising:
disposing a substrate a platen and a stamper comprising a negative of a desired surface feature, wherein the stamper is affixed to a magnetically permeable block comprising an induction coil, and wherein the stamper comprises a relative magnetic permeability gradient;
pressing the stamper and the substrate together;
passing an alternating electrical current through the induction coil; and
changing the alternating electrical current in the induction coil;
wherein the embossed substrate is formed.

14. The method of claim 12, further comprising flowing thermally convective medium through thermal channels in the magnetically permeable block to cool the substrate to a temperature below the softening temperature.

15. The method of claim 14, wherein the induction coil forms the thermal channels.

16. A data storage media manufactured from the method of claim 1.

17. A data storage media manufactured from the method of claim 13.

18. An apparatus for embossing, comprising:
a first magnetically permeable block comprising an induction coil disposed in a recess; and
a first stamper disposed in operable communication with to the first magnetically permeable block, wherein the first stamper comprises a first negative of desired surface features.

19. The apparatus of claim 18, wherein the magnetically permeable block has a relative magnetic permeability of less than or equal to about 10 and the stamper has a relative magnetic permeability of greater than or equal to about 200.

20. The apparatus of claim 19, wherein the magnetically permeable block has a relative magnetic permeability of less than or equal to about 5 and the stamper has a relative magnetic permeability of greater than or equal to about 500.

21. The apparatus of claim 17, wherein the magnetically permeable block has a relative magnetic permeability of less than or equal to about 2 and the stamper has a relative magnetic permeability of greater than or equal to about 1,000.

22. The apparatus of claim 18, wherein the stamper comprises a relative magnetic permeability gradient.

23. The apparatus of claim 18, wherein the induction coil comprises a hollow conduit forming a thermal channel capable of receiving a thermally convective medium.

24. The apparatus of claim 18, wherein the induction coil comprises a coating on the walls of a channel capable of receiving a thermally convective medium.

25. The apparatus of claim 18, further comprising second magnetically permeable block comprising a second induction coil; and
a second stamper affixed to the second magnetically permeable block, wherein the second stamper comprises a second negative of desired second surface features, and wherein the second negative is disposed on a side of the second stamper facing the first negative.
